(19) United States
(12) Patent Application Publication
(10) Pub. No.: US 2017/0045605 A1
(43) Pub. Date: Feb. 16, 2017

(54) ARRANGEMENT FOR, AND METHODOF, ACCURATELY AND RAPIDLY LOCATING AND TRACKING A MOBILE DEVICE IN A VENUE

(71) Applicant: SYMBOL TECHNOLOGIES, LLC, Lincolnshire, IL (US)

(72) Inventor: DAMMIKA PRASAD WIJETHUNGA, BORALANKADA (LK)

(21) Appl. No.: 14/824,122

(22) Filed: Aug. 12, 2015

(51) Int. Cl. G01S 5/26

(52) U.S. Cl. CPC G01S 5/26

(57) ABSTRACT

Ultrasonic transmitters periodically transmit ranging signals, and an ultrasonic receiver receives the ranging signals on a mobile device movable along a tracking path in a venue. The most recent, successive, historical positions at which the mobile device had been along the tracking path is determined. A current, real-time position of the mobile device is obtained by determining an intermediate estimated position of the mobile device based at least partly on the last historical position, and by averaging the intermediate estimated position, together with a variable number of the historical positions. The number of the historical positions is varied as a function of a speed of the mobile device.

### BACKGROUND OF THE INVENTION

The present disclosure relates generally to an arrangement for, and a method of, accurately locating and tracking a mobile device, such as a handheld data capture reader, a smartphone, a tablet, a computer, a radio, or a like electronic device, that is movable along a tracking path in a venue, such as a retail store, a factory, a warehouse, a distribution center, a building, or a like indoor controlled area.

It is known to deploy a real-time ultrasonic locationing system in an indoor venue, such as a retail store, a factory, a warehouse, a distribution center, a building, or a like controlled area, to locate and to track a mobile device, such as a handheld data capture reader, a smartphone, a tablet, a computer, a radio, or a like electronic device. A known ultrasonic locationing system includes an ultrasonic transmitter subsystem having a plurality of ultrasonic transmitters mounted at fixed, known locations spaced apart in the venue, each ultrasonic transmitter being operative, in its turn, for periodically transmitting ultrasonic ranging signals, e.g., ultrasonic pulses in the 20-22 kHz frequency range, to an ultrasonic receiver subsystem having a microphone mounted on, and jointly movable with, the mobile device. The ultrasonic locationing system locates the position, and tracks the movement, of the mobile device along a tracking path within the venue, typically by using differential flight time techniques known in the art that incorporate triangulation, trilateration, multilateration, and like techniques.

Under ideal operating conditions, each transmitter periodically transmits the ranging signals directly along direct, non-folded paths to the microphone. The flight time difference between the transmit time at which each ranging signal is transmitted and the receive time at which each ranging signal is received along each direct path, together with the known speed of each ranging signal, as well as with the known locations of the transmitters, are used, among other factors, to determine the distance along each direct path, and, in turn, the position of the microphone mounted on the mobile device, and, in turn, the location of the mobile device.

However, the operating conditions of the known ultrasonic locationing system are sometimes less than ideal. The ultrasonic locationing system is subject to multi-path reflections and scattering of its ultrasonic ranging signals off various reflecting and/or absorbing surfaces, such as walls, ceilings, floors, curtains, windows, shelves, equipment, and myriad other objects or persons, in the venue, thereby attenuating, and sometimes even blocking or substantially absorbing, the ultrasonic ranging signals by such surfaces. For example, ultrasonic ranging signals do not pass through walls, and may also be subject to interference from ambient loud noise. An ultrasonic ranging signal subjected to such multi-path reflections travels from each transmitter along an indirect, reflected, folded path to the microphone. This indirect, reflected path is longer than the aforementioned direct path and leads to an erroneous determination of the location of the microphone and of the mobile device that carries the microphone.

In addition, each transmitter must wait for the longest possible flight time for its ranging signal to be received before having the other transmitters transmit their ranging signals. If not, ranging signal collisions could occur, and some ranging signals would not be received properly, i.e., they would be missed by the microphone. A reasonable maximum flight time, such as 200 ms, which is approximately 200 feet for ultrasonic ranging signals, is typically established for a venue, and represents the farthest distance apart between the farthest transmitter and the microphone where the microphone is still able to reliably receive (hear) each ultrasonic ranging signal. Therefore, to ensure that ultrasonic ranging signals are not missed, the transmissions by the ultrasonic transmitters are staggered apart and delayed by at least this maximum flight time. However, such time delays may also lead to an erroneous determination of the location of the mobile device and its microphone. Determination of the location of the mobile device by triangulation requires that the transmit times from at least three transmitters be processed, and the aforementioned time delays prevent the real-time position of the mobile device from being accurately and/or rapidly determined in real time, especially if the mobile device has moved during such time delays while waiting for all the transmitters to transmit their ranging signals.

Accordingly, it would be desirable to more accurately and more rapidly locate and track a mobile device in a venue by an ultrasonic locationing system.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an arrangement for locating and tracking a mobile device along a tracking path in a venue in accordance with the present disclosure.

FIG. 2 is a simplified diagram, as seen in top plan view, of an arrangement of the general type shown in FIG. 1, as operated to locate a mobile device by triangulation in a venue in accordance with the prior art.

FIG. 3 is a diagram analogous to FIG. 2, but showing how the arrangement of FIG. 1 more accurately and more rapidly locates and tracks a mobile device along a tracking path in a venue in accordance with the present disclosure.

FIG. 4 is a flow chart depicting steps performed in accordance with the method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for locating and tracking a mobile device that is movable along a tracking path in a venue. The mobile device can be any electronic device, such as a handheld radio frequency (RF) identification (RFID) tag reader, a handheld bar code symbol reader, a smartphone, a tablet, a computer, a radio, or the like. The venue can be any indoor environment, such as a retail store, a factory, a warehouse, a distribution center, a building, or a like indoor controlled area. The arrangement comprises a real-time locationing system including a transmitter subsystem having a plurality of ultrasonic transmitters that are spaced apart of one another at fixed locations in the venue. For example, the ultrasonic transmitters can be mounted overhead at known positions on a ceiling at the venue. Each ultrasonic transmitter is operative, in its turn, for periodically transmitting a plurality of ultrasonic ranging signals. The locationing system also includes a receiver subsystem spaced away from the transmitter subsystem. The receiver subsystem, preferably including a microphone, is supported by, and is jointly movable with, the mobile device in the venue. The receiver subsystem is operative for receiving the ultrasonic ranging signals.

The arrangement further comprises a controller, preferably a programmed microprocessor, operatively connected to the locationing system and operative for determining a series of most recent, successive, historical positions at which the mobile device had been along the tracking path, and for determining a current, real-time position at which the mobile device currently is along the tracking path. The current, real-time position is determined by determining an intermediate estimated position of the mobile device based, at least in part, on a last one of the historical positions, and by averaging the intermediate estimated position together with a variable number of the historical positions. The controller further determines a speed of the mobile device, and varies the number of the historical positions as a function of the speed of the mobile device.

Preferably, a pair of the transmitters transmit their respective ranging signals over coverage zones that intersect each other at intersection points, and the controller determines the closest intersection point that is closest to the last most recent historical position of the mobile device, and also determines the intermediate estimated position based on both the closest intersection point and the last most recent historical position of the mobile device. Advantageously, the determination of the intermediate estimated position is performed by weighting the last most recent historical position of the mobile device more heavily than the closest intersection point. For example, the last most recent historical position can be weighted by a 75% factor, and the closest intersection point can be weighted by a 25% factor.

Advantageously, the number of the most recent historical positions is decreased when the speed of the mobile device exceeds a threshold speed indicative of a normal walking speed of a human (about 1.4 meters per second), and the number of the most recent historical positions is increased when the speed of the mobile device is below the threshold speed.

Another aspect of this disclosure relates to a method of locating and tracking a mobile device that is movable along a tracking path in a venue. The method is performed by spacing a plurality of ultrasonic transmitters apart of one another at fixed locations in the venue, by periodically transmitting a plurality of ultrasonic ranging signals from each of the transmitters in its turn, by supporting a receiver subsystem on the mobile device away from the transmitter subsystem for joint movement with the mobile device in the venue, and by receiving the ultrasonic ranging signals at the receiver subsystem. The method is further performed by determining a series of most recent, successive, historical positions at which the mobile device had been along the tracking path, by determining a current, real-time position at which the mobile device currently is along the tracking path, by determining an intermediate estimated position of the mobile device based, at least in part, on a last one of the historical positions, by averaging the intermediate estimated position together with a variable number of the historical positions, by determining a speed of the mobile device, and by varying the number of the historical positions as a function of the speed of the mobile device.

In accordance with this disclosure, the position or location of the mobile device is more rapidly and more accurately determined, because, among other factors, it is no longer necessary to wait for the transmit times from at least three of the transmitters to be processed, and errors due to multi-path reflections are minimized

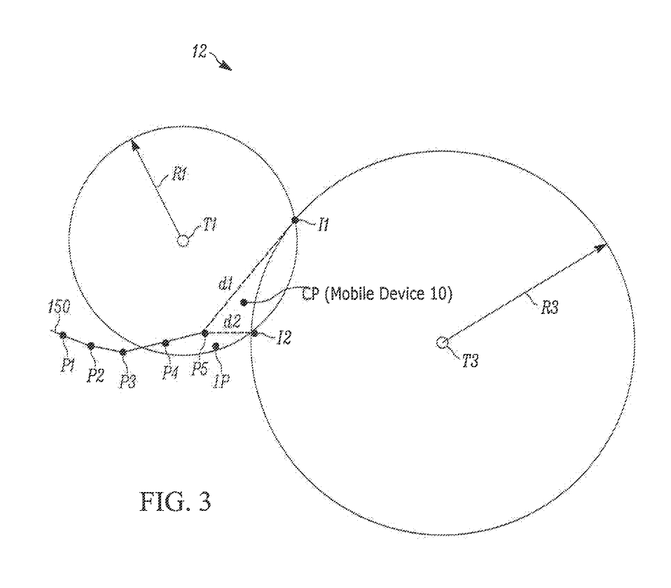

Referring now to the drawings, reference numeral 10 identifies a mobile device 10 movable along a tracking path 150 (see FIG. 3) in a venue 12. The mobile device 10 can be any electronic device, such as a handheld radio frequency (RF) identification (RFID) tag reader, a handheld bar code symbol reader, a smartphone, a tablet, a computer, a radio, or the like. The venue 12 can be any indoor environment, such as a retail store, a factory, a warehouse, a distribution center, a building, or a like indoor controlled area. A real-time locationing system is provided to determine the location, and to track the position, of the mobile device 10 along the tracking path 150 in the venue 12. The locationing system includes an ultrasonic transmitter subsystem 110 for transmitting ultrasonic ranging signals 130A, 130B, 130C to an ultrasonic receiver subsystem 120.

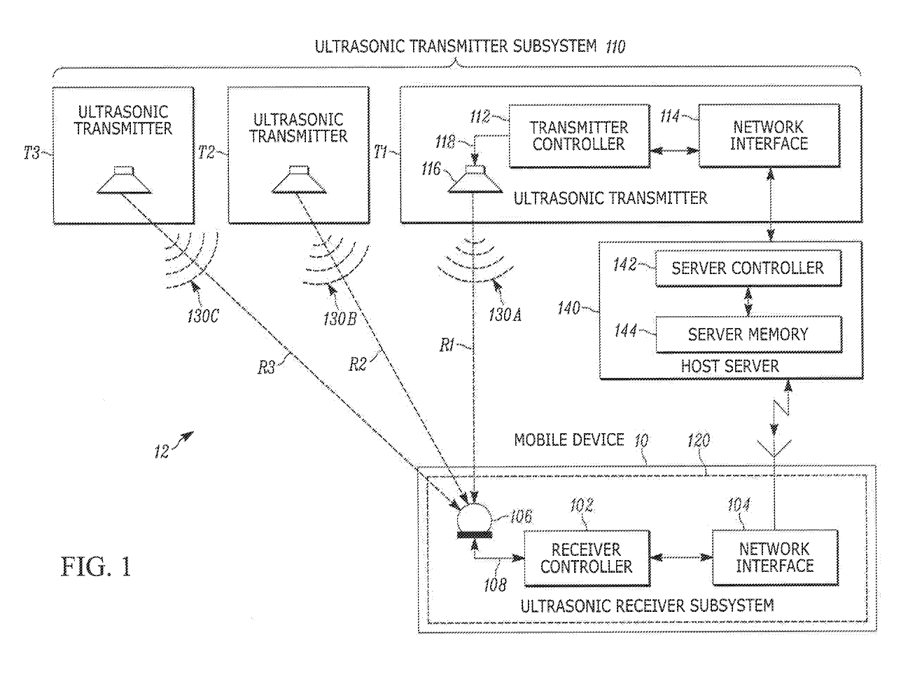

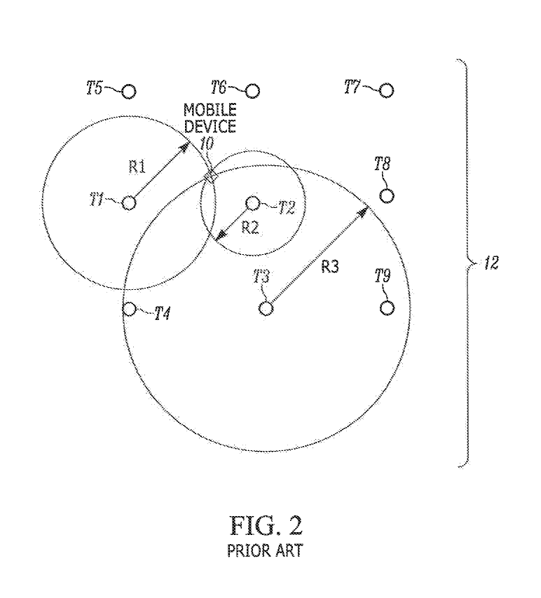

As shown in FIG. 1, the ultrasonic transmitter subsystem 110 includes a plurality of ultrasonic transmitters T1, T2, T3 that are spaced apart at known, fixed locations in the venue, for example, by being mounted overhead on a ceiling. The ultrasonic receiver subsystem 120 is mounted on, and is jointly movable with, the mobile device 10 below the ceiling. Each ultrasonic transmitter T1, T2, T3 periodically transmits the ultrasonic ranging signals 130A, 130B, 130C, preferably in short bursts or ultrasonic pulses, which are received by the ultrasonic receiver subsystem 120 on the mobile device 10. Although only three ultrasonic transmitters T1, T2, T3 have been illustrated in FIG. 1, it will be understood that many more than three could be, and often are, provided in a particular venue 12. For example, an array of nine transmitters is shown in FIG. 2, and some venues may have thirty, or fifty, or one hundred or more transmitters.

A host server 140, also known as a backend server, is operatively connected over wired and/or wireless connections to the transmitter subsystem 110, the receiver subsystem 120, and the mobile device 10. The host server 42 has a programmed microprocessor or server controller 142 that controls the subsystems 110, 120 and the mobile device 10, and a server memory 144 for storing data and programs under the control of the server controller 142.

The server controller 142 of the host server 140 is operatively connected through a network interface 114 via a programmed microprocessor or transmitter controller 112 to generate a transmit drive signal on line 118 to drive an emitter 116, preferably a voice coil speaker, but could also be a piezoelectric speaker, in each transmitter T1, T2, T3 of the transmitter subsystem 110. The non-illustrated components for ultrasonic transmitters T2 and T3 are the same as those shown for the ultrasonic transmitter T1. The server controller 142 directs all the ultrasonic transmitters T1, T2, T3 to emit the ultrasonic ranging signals 130A, 130B, 130C at different staggered times, for example, 200 ms apart, as described below, such that the receiver subsystem 120 on the mobile device 10 will not receive overlapping ranging signals from the different ultrasonic transmitters.

The receiver subsystem 120 includes a transducer, such as an existing microphone 106, on the mobile device 10 to receive and convert each ultrasonic ranging signal 130A, 130B, 130C to an electrical signal on line 108 that is processed by an existing programmed microprocessor or receiver controller 102. A network interface 104 at the output of the receiver controller 102 provides wireless communication with the server controller 142 of the host server 140.

Under ideal operating conditions, the transmitter subsystem 110 periodically transmits the ranging signals 130A, 130B, 130C directly along direct, non-folded paths R1, R2, R3 to the receiver subsystem 120. The flight time difference between the transmit time that each ranging signal 130A, 130B, 130C is transmitted and the receive time that each ranging signal 130A, 130B, 130C is received along each direct path R1, R2, R3, together with the known speed of each ranging signal 130A, 130B, 130C, as well as the known and fixed locations and positions of the transmitters T1, T2, T3, are all used to determine the distance along, or length of, each direct path R1, R2, R3, and, in turn, the position of the receiver subsystem 120 mounted on the mobile device 10, and, in turn, the position of the mobile device 10, using a suitable locationing technique, such as triangulation, trilateration, multilateration, etc.

FIG. 2 depicts, in a top plan view, how multiple transmitters typically cooperate to locate a mobile device by triangulation. An array of nine equally spaced apart transmitters T1-T9 is arranged in mutually orthogonal rows and columns throughout a venue. Using the reference numerals employed in FIG. 1, three of the transmitters T1, T2, T3 transmit their respective ranging signals over generally circular coverage zones whose radii are the aforementioned distances of the direct paths R1, R2, R3. The mobile device 10 is located in the venue 12 at the common intersection point of all three circular zones. However, this locationing technique is not altogether satisfactory, because the host server 140 must wait for the longest possible flight time for each ranging signal 130A, 130B, 130C transmitted, for example, by the transmitter T1 to be received by the microphone 106 before having the other transmitters T2 and T3 transmit their ranging signals. If not, ranging signal collisions could occur, and some ranging signals would not be received properly, i.e. they would be missed by the microphone 106.

Therefore, it is preferred to establish a maximum flight time for the venue 12, i.e., the farthest distance apart for the transmitter and receiver subsystems 110, 120 where the microphone 106 is still able to reliably receive (hear) each ultrasonic ranging signal. In other words, ranging signals may not readily be detected at long distances, such as those of a large hall. Therefore, a reasonable maximum flight time can be established, such as 200 ms, which is approximately 200 feet for the ultrasonic ranging signals. This maximum flight time can be estimated or empirically determined in the actual venue 12. Therefore, to ensure that ultrasonic ranging signals are not missed, a worst case flight time is determined within the venue 12 to define a maximum buffer time period, and to subsequently delay any ultrasonic transmitter from transmitting by at least this maximum buffer time period.

In addition to this delay which slows down the determination of the position of the mobile device 10, the ultrasonic locationing system is subject to multi-path reflections and scattering of its ultrasonic ranging signals off various reflecting and/or absorbing surfaces, such as walls, ceilings, floors, curtains, windows, shelves, equipment, and myriad other objects or persons, in the venue, thereby attenuating, and sometimes even blocking or substantially absorbing, the ultrasonic ranging signals by such surfaces. For example, ultrasonic ranging signals do not pass through walls, and may also be subject to interference from ambient loud noise. An ultrasonic ranging signal subjected to such multi-path reflections travels from the transmitter subsystem 110 along an indirect, reflected, folded path to the receiver subsystem 120, which is longer than the distance or length of the direct path and therefore leads to an erroneous determination of the position of the receiver subsystem 120 mounted on the mobile device 10.

In accordance with this invention, a controller, preferably a programmed microprocessor, constituted by the server controller 142 and/or the transmitter controller 112 and/or the receiver controller 102, is operative, as shown in FIG. 3, for determining a series or number N of the most recent, successive, historical locations or positions P1 . . . PN (as shown, P1, P2, P3, P4, and P5) at which the mobile device 10 had previously been along the tracking path 150 in the venue 12. In this case, only two of the transmitters, e.g., T1 and T3, are employed to eliminate the prior art delay needed by a third transmitter. Although five recent historical positions have been illustrated, it will be understood that a different number N of the most recent historical positions could be employed and stored in the server memory 144 for subsequent processing.

In addition, the controller determines a current real-time position CP at which the mobile device 10 is currently along the tracking path 150. The current position CP is obtained by first determining an intermediate estimated position IP of the mobile device 10 based, at least in part, on the last one, e.g., P5, of the historical positions of the mobile device 10. Preferably, the transmitters T1 and T3 transmit their respective ranging signals over circular coverage zones, as seen in the top plan view of FIG. 3, that intersect each other at intersection points I1 and I2, which are located based on such factors as, among others, flight time differences between the receive and transmit times of the ultrasonic ranging signals, the known speed of each ultrasonic ranging signal, and the known locations of the transmitters T1 and T3. The controller next determines the distance d1 between the last historical position P5 and the intersection point I1, as well as the distance d2 between the last historical position P5 and the intersection point I2. The controller next compares the distances d1 and d2, and determines which of the intersection points is the closest to the last historical position P5. Since d2 is shorter and less than d1, as illustrated in FIG. 3, the closest intersection point is I2, which is also sometimes referred to herein as the “effective” intersection point. If the circular zones of the transmitters T1 and T3 are tangent to each other, then the tangent point is considered to be the effective intersection point. If the circular zones of the transmitters T1 and T3 do not overlap, then the last historical position P5 is considered to be the effective intersection point.

The controller preferably determines the intermediate estimated position IP based on both the closest (or effective) intersection point I2 and the last historical position P5 of the mobile device 10. Advantageously, the determination of the intermediate estimated position IP is performed by weighting the last historical position P5 more heavily than the closest (or effective) intersection point I2. For example, the last historical position P5 can be weighted by a factor of at least 60%, preferably as high as 75%, and the closest (or effective) intersection point I2 can be weighted by a factor of at least 40%, preferably as low as 25%. The preferred relationship can be mathematically expressed by the following expression:

IP=¾P5+¼I2

The controller next averages the intermediate estimated position IP together with a variable number N of the historical positions P1 . . . PN of the mobile device 10. The number N of the historical positions P1 . . . PN is varied as a function of the speed of the mobile device 10. The controller determines the speed of the mobile device 10 based on the historical positions P1 . . . PN of the mobile device 10. The relationship in the preferred embodiment shown in FIG. 3 can be mathematically expressed by the following expression:

CP=(IP+P1+P2+P3+P4+P5)/(N+1),

where N=5.

The number N of the historical positions is decreased when the speed of the mobile device 10 exceeds a threshold speed indicative of a normal walking speed of a human (about 1.4 meters per second), and the number N of the historical positions is increased when the speed of the mobile device 10 is below the threshold speed. The threshold speed is stored in the server memory 144. Thus, the current position CP of the mobile device 10 is determined based on the intermediate point IP (which, in turn, is based on the last historical position P5 and/or the effective intersection point I2), as well as the most recent successive historical positions P1 . . . PN of the mobile device 10.

When the mobile device 10 is near a wall, the accuracy of the current position CP will suffer due to ultrasonic reflections from the wall. Since this will result in a decrease in the update rate of the most recent historical positions, it is desirable, in this case, to decrease the number N of the historical positions, which accounts for the determination of the current position CP, to maintain a good update rate. Also, the controller can monitor the aforementioned distance d2 to see whether it is greater than a threshold distance that a human can normally walk in the given time. To reduce wall effect errors, the controller ignores the effective intersection point I2 and uses the last historical position P5 for further processing when the distance d2 exceeds the threshold distance.

To reduce multi-path reflection errors, the controller advantageously uses transmitters that are on different rows and different columns. For example, as shown in FIGS. 2-3, the transmitters T1 and T3 are located on different rows and columns, and are not on the same row or column. Also, the controller advantageously ignores any transmitter whose coverage zone has a very small radius, which is a minor fraction of the radii of the zones of the other transmitters.

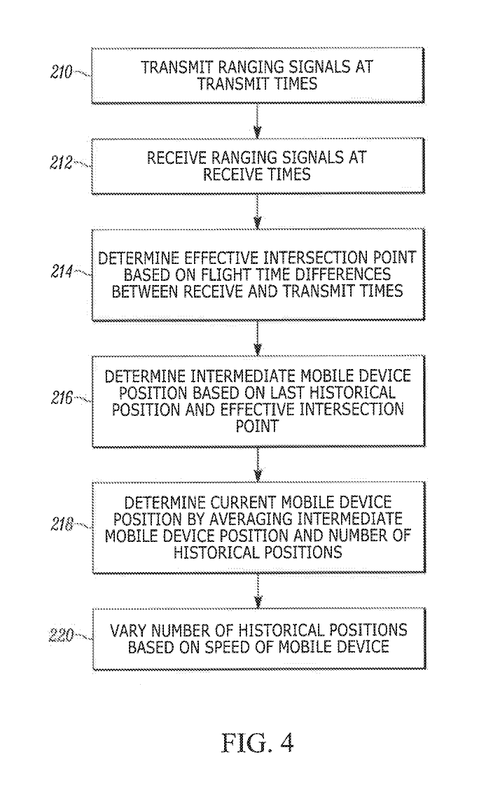

The above-disclosed method is performed, as shown in the flow chart of FIG. 4, by periodically transmitting a plurality of ranging signals 130A, 130B, 130C at transmit times by operation of a transmitter subsystem 110 in step 210, and by receiving the ranging signals 130A, 130B, 130C at receive times by operation of a receiver subsystem 120 in step 212. The subsystems 110, 120 are spaced apart from each other in a venue 12, and the receiver subsystem 120 is supported on a mobile device 10 for joint movement therewith in the venue 12.

The method is further performed by determining a current real-time 5position CP of the mobile device 10 by determining an effective intersection point I2 which is closest to the last, e.g., P5, of the most recent, successive, historical positions P1 . . . PN in step 214, by determining an intermediate estimated position IP of the mobile device 10 as a function of the last historical position, e.g., P5, and/or of the effective intersection point I2 in step 216, by averaging the intermediate estimated position IP together with a variable number N of the historical positions P1 . . . PN of the mobile device 10 in step 218, and by varying the number N of the historical positions P1 . . . PN as a function of the speed of the mobile device 10 in step 220.

The method continues by having the controller determine the next position along the tracking path 150 to which the mobile device 10 is subsequently moved away from the current position CP by subsequently treating the determined current position CP as the last one of the historical positions. Thus, each historical position P1 . . . PN was obtained by the above-described determination of the intermediate estimated position, followed by the above-described determination of the current position, but with the determined current position CP being substituted for the last one of the historical positions for each successive position of the mobile device 10.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for locating and tracking a mobile device movable along a tracking path in a venue, the arrangement comprising:
a real-time locationing system including a transmitter subsystem having a plurality of ultrasonic transmitters that are spaced apart of one another at fixed locations in the venue, each ultrasonic transmitter being operative, in its turn, for periodically transmitting a plurality of ultrasonic ranging signals, and a receiver subsystem spaced away from the transmitter subsystem and being supported by, and movable with, the mobile device in the venue, the receiver subsystem being operative for receiving the ultrasonic ranging signals; and
a controller operatively connected to the locationing system and operative for determining a series of most recent, successive, historical positions at which the mobile device had been along the tracking path,
the controller being further operative for determining a current, real-time position at which the mobile device currently is along the tracking path, by determining an intermediate estimated position of the mobile device based, at least in part, on a last one of the historical positions, and by averaging the intermediate estimated position together with a variable number of the historical positions, and
the controller being further operative for determining a speed of the mobile device, and for varying the number of the historical positions as a function of the speed of the mobile device.

2. The arrangement of claim 1, wherein a pair of the transmitters transmit their respective ranging signals over coverage zones that intersect each other at intersection points; and wherein the controller is configured to determine the closest intersection point that is closest to the last one of the historical positions, and wherein the controller determines the intermediate estimated position based on both the closest intersection point and the last one of the historical positions of the mobile device.

3. The arrangement of claim 2, wherein the transmitters are arranged in rows and columns, and wherein the transmitters of the pair are located at different rows and different columns.

4. The arrangement of claim 2, wherein the controller determines the intermediate estimated position by weighting the last one of the historical positions of the mobile device more heavily than the closest intersection point.

5. The arrangement of claim 1, wherein the controller is configured to decrease the number of the historical positions when the speed of the mobile device exceeds a threshold speed indicative of a normal walking speed of a human, and to increase the number of the historical positions when the speed of the mobile device is below the threshold speed.

6. The arrangement of claim 1, wherein the controller determines a next position to which the mobile device is subsequently moved away from the current position by successively treating the determined current position as the last one of the historical positions.

7. The arrangement of claim 1, and further comprising a host server for controlling the subsystems, and wherein the controller is mounted in at least one of the host server and the subsystems.

8. An arrangement for locating and tracking a mobile device movable along a tracking path in a venue, the arrangement comprising:
a real-time locationing system including a transmitter subsystem having a plurality of ultrasonic transmitters that are spaced apart of one another at fixed locations in the venue, each ultrasonic transmitter being operative, in its turn, for periodically transmitting a plurality of ultrasonic ranging signals, and a receiver subsystem spaced away from the transmitter subsystem and being supported by, and movable with, the mobile device in the venue, the receiver subsystem being operative for receiving the ultrasonic ranging signals; and
a controller operatively connected to the locationing system and operative for determining a series of most recent, successive, historical positions at which the mobile device had been along the tracking path,
the controller being further operative for determining a current, real-time position at which the mobile device currently is along the tracking path, by determining an intermediate estimated position of the mobile device based, at least in part, on a last one of the historical positions, and by averaging the intermediate estimated position together with a variable number of the historical positions, and
the controller being further operative for determining a speed of the mobile device, and for varying the number of the historical positions as a function of the speed of the mobile device by decreasing the number of the historical positions when the speed of the mobile device exceeds a threshold speed indicative of a normal walking speed of a human, and by increasing the number of the historical positions when the speed of the mobile device is below the threshold speed.

9. The arrangement of claim 8, wherein a pair of the transmitters transmit their respective ranging signals over coverage zones that intersect each other at intersection points; and wherein the controller is configured to determine the closest intersection point that is closest to the last one of the historical positions, and wherein the controller determines the intermediate estimated position based on both the closest intersection point and the last one of the historical positions of the mobile device.

10. The arrangement of claim 9, wherein the transmitters are arranged in rows and columns, and wherein the transmitters of the pair are located at different rows and different columns.

11. The arrangement of claim 9, wherein the controller determines the intermediate estimated position by weighting the last one of the historical positions more heavily than the closest intersection point.

12. The arrangement of claim 8, wherein the controller determines a next position to which the mobile device is subsequently moved away from the current position by successively treating the determined current position as the last one of the historical positions.

13. The arrangement of claim 8, and further comprising a host server for controlling the subsystems, and wherein the controller is mounted in at least one of the host server and the subsystems.

14. A method of locating and tracking a mobile device movable along a tracking path in a venue, the method comprising:
spacing a plurality of ultrasonic transmitters apart of one another at fixed locations in the venue;
periodically transmitting a plurality of ultrasonic ranging signals from each of the transmitters in its turn;
supporting a receiver subsystem on the mobile device away from the transmitter subsystem for joint movement with the mobile device in the venue;
receiving the ultrasonic ranging signals at the receiver subsystem;
determining a series of most recent, successive, historical positions at which the mobile device had been along the tracking path;
determining a current, real-time position at which the mobile device currently is along the tracking path, by determining an intermediate estimated position of the mobile device based, at least in part, on a last one of the historical positions, and by averaging the intermediate estimated position together with a variable number of the historical positions;
determining a speed of the mobile device; and
varying the number of the historical positions as a function of the speed of the mobile device.

15. The method of claim 14, wherein the transmitting is performed by a pair of the transmitters that transmit their respective ranging signals over coverage zones that intersect each other at intersection points; and determining the closest intersection point that is closest to the last one of the historical positions, and determining the intermediate estimated position based on both the closest intersection point and the last one of the historical positions.

16. The method of claim 15, and arranging the transmitters in rows and columns, and locating the transmitters of the pair at different rows and different columns.

17. The method of claim 15, wherein the determining of the intermediate estimated position is performed by weighting the last one of the historical positions more heavily than the closest intersection point.

18. The method of claim 14, wherein the varying is performed by decreasing the number of the historical positions when the speed of the mobile device exceeds a threshold speed indicative of a normal walking speed of a human, and by increasing the number of the historical positions when the speed of the mobile device is below the threshold speed.

19. The method of claim 14, and determining a next position to which the mobile device is subsequently moved away from the current position by successively treating the determined current position as the last one of the historical positions.

20. The method of claim 14, and controlling the subsystems with a host server.
